(19) United States
(12) Patent Application Publication
(10) Pub. No.: US 2014/0140040 A1
(43) Pub. Date: May 22, 2014

(54) ENERGIZING SYSTEM OF REMOVABLE COMPONENTS PROVIDED WITH ELECTRIC-ELECTRONIC DEVICES AND ELECTRIC DRIVING METHOD FOR DEVICES DISPOSED IN REMOVABLE COMPONENTS

(71) Applicant: Whirlpool S.A., Sao Paulo (BR)

(72) Inventors: Neomar Giacomini, Joinville (BR); Phabio Junckes Setubal, Joinville (BR)

(73) Assignee: Whirlpool S.A., Sao Paulo (BR)

(21) Appl. No.: 14/086,443

(22) Filed: Nov. 21, 2013

(30) Foreign Application Priority Data
Nov. 22, 2012 (BR) 10 2012 029702 7

(51) Int. Cl. F25D 27/00; H02J 17/00

(52) U.S. Cl. CPC F25D 27/005; H02J 17/00
USPC 362/92

(57) ABSTRACT

The present invention, which aims at solving the problem of supplying electricity to removable components of household appliances and other apparatuses in general, pertains to the field of parts and accessories for household appliances and refers to removable components of equipments comprising wireless powered electronic devices. More specifically, the present invention is directed to removable shelves comprising illuminating means, in which their power supply is wireless.

### RELATED APPLICATION

This application claims priority to Brazil Application No. BR 10 2012 029702 7, filed on 22 Nov. 2012, the contents of which are herein incorporated by reference in its entirety.

### FIELD OF THE INVENTION

The present invention pertains to the field of parts and accessories for household appliances and refers to removable components of equipments comprising wireless powered electronic devices. More specifically, the present invention refers to removable shelves comprising illuminating means, wherein their electric power supply is carried out without the need of wires for interconnecting the power source ant the element to be supplied.

### BACKGROUND OF THE INVENTION

As widely known, several removable-type elements, such as shelves, are employed in a variety of applications. Due to their ease of being re-arranged in different heights and shapes, removable shelves are commonly used in a number of equipments, wherein a typical use of such removable elements is in refrigerators.

However, it occurs that even in apparatuses using removable shelves the inner illumination of refrigerators is made with lamps disposed in the upper-rear region of the inner compartment, thereby resulting in making difficult to visualize the food products arranged on the lower shelves. Furthermore, the position of the light source in the compartment rear region causes the products stored therein to block the light such that the correction illumination of the interior of a refrigerator is impaired.

Some solutions, such as, for example, the one disclosed in U.S. Pat. No. 5,297,836 refers to a different type of illumination using a vertical fluorescent lamp secured to the front structure of the chamber which however is also attached to the equipment housing.

In an attempt to solve the problem of suitable inner illumination, there have been developed shelves which are themselves provided with light sources capable of appropriately illuminating the entire inner region of a refrigerator—as shown, for example, in U.S. Pat. No. 7,107,779 and WO 2009/014885, in which however the light sources are disposed at the rear portions of the parts such that when the chamber is full the light passage to the front region may be blocked.

U.S. Pat. No. 5,287,252 refers to a movable shelf provided with a front illumination system, however, to assemble it, wires and other elements (e.g. a conductive strip and connectors) are required to bring into contact the shelf with a power source, which is usually disposed at the equipment housing itself.

Further, WO 2011/019589 and U.S. Pat. No. 6,813,896 disclose removable illuminated shelves which, however, require the use of two side power buses to supply electricity to the lamps and in addition they use connectors to obtain power from the power bus, which renders such construction and mounting of equipments complex and expensive.

In brief it can be observed that the state of the art lacks solutions for illuminating shelves of several equipments, mainly refrigerators which will work without using electric wiring (wireless function) and may utilize their only structure as connectors to thereby minimize the amount of components and installations required for their perfect operation.

### OBJECTS OF THE INVENTION

Thus, one of the objects of the present invention is to provide power supply to all wireless electronic devices of removable components, preferably shelves.

Another object of the present invention is to provide removable components for household appliances and equipments in general which can be electrically connected to a power source with no need to use further electric components, such as, for example, connectors.

Yet another object of the present invention is to provide a removable component which can simultaneously use its own structure as electric connector and aesthetic finishing.

### SUMMARY OF THE INVENTION

The objects mentioned above are achieved by means of an energizing system of removable components for equipments in general, more specifically for household appliances provided with elements removably secured to support structures of the equipment housing, wherein said elements are provided with electric or electronic driving devices, said system comprising at least an element comprising a surface portion containing a conductive material cooperative with at least a fixed structure of the equipment, wherein said surface portion containing conductive material is connected to the electric driving device, and at least a fixed structure comprising at least a conductive region cooperative with said conductive material of the elements, wherein said conductive region is connected to an electric power source.

In brief, the present invention comprises means for allowing wireless electric connection between at least an element removably secured to at least a support structure of equipment and structure 3 of the equipment.

In a preferred embodiment of the invention, said element comprises: a transparent flat plate having a perimeter covered with a frame provided with, under one or more of the surfaces thereof, an electric or electronic driving system, wherein side elements having ends provided with engaging/securing means for coupling with the conductive regions contained in the support structures of the refrigerator housing are disposed together the side portions of the frame.

Preferably, said frame is constituted by an electric conductive material at least in the interconnection region between the electric driving device and conductive regions contained in the support structures.

In a preferred embodiment, the electric driving devices are light emitting devices (LEDs).

In a further preferred embodiment, the power source is a low voltage power source.

Another object of the present invention refers an electric driving method for devices disposed at removable components for equipments in general comprising the step of contacting at least a portion of an electric conductive surface of a removable component comprising at least an electronic component with at least a portion of electric conductive surface of a fixed structure, wherein said structure fixed structure is connected to an electric power source.

### BRIEF DESCRIPTION OF THE DRAWINGS

FIG. 1 illustrates a perspective view of an inner region of an equipment, more specifically a refrigerator, to which a removable component provided with an electric-electronic device in accordance with the present invention is coupled;

FIG. 2 illustrates a lower perspective view of the equipment depicted in FIG. 1;

FIG. 3 illustrates a perspective front view of the equipment depicted in FIG. 1; and

FIG. 4 illustrates a perspective view of an amplified detail of a coupling form between the shelf and the structure of the equipment depicted in FIG. 1.

### DETAILED DESCRIPTION OF THE INVENTION

The present invention will be described in detail on the basis of the appended figures.

The energizing system of the present invention basically comprises a element 1 removably secured to a support structure 2 coupled with or disposed in housing 3 of equipment 4 which as formerly said is preferably a refrigerator.

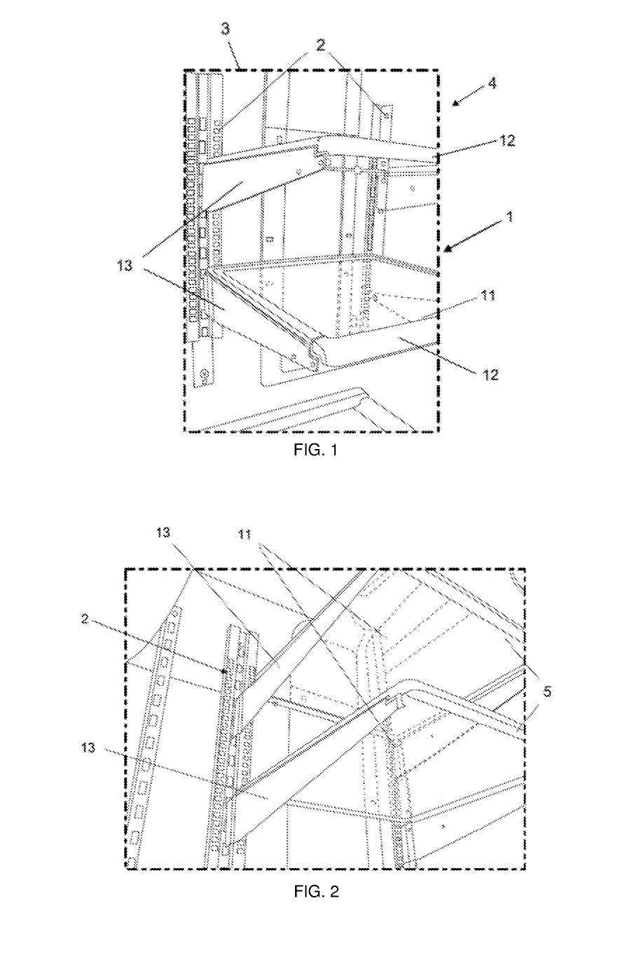

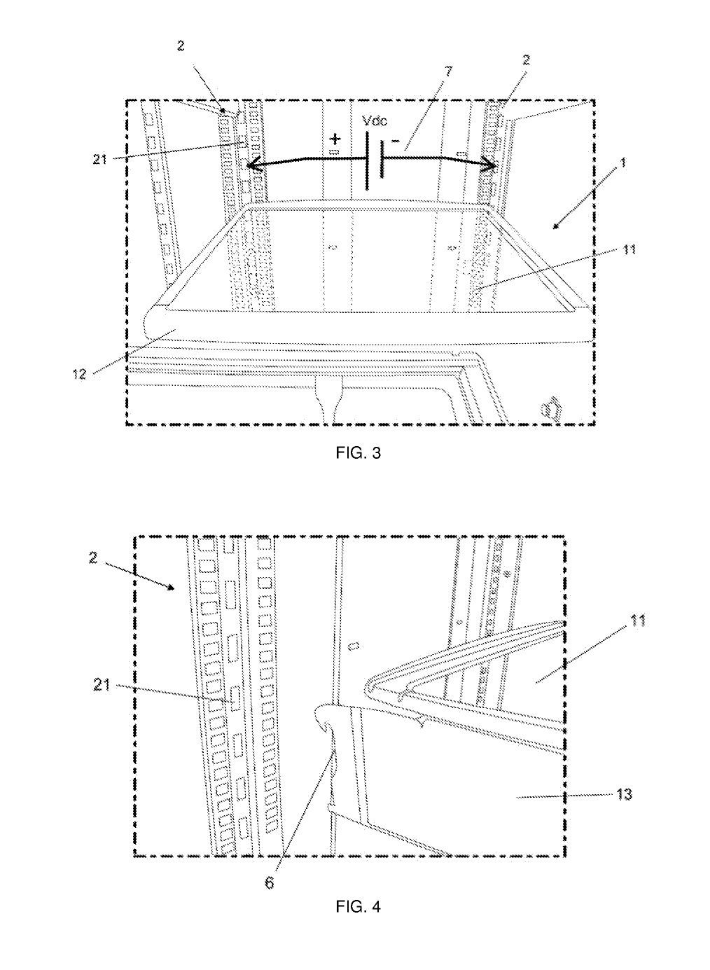

As can be seen from FIG. 1, said element 1 is preferably defined by a preferably transparent flat plate 11 having a perimeter covered with a frame 12 provided with, under or more of its surfaces, an electric or electronic driving system, such as, for example, a LEDs plate (shown in FIG. 2).

It should be pointed out that at least a portion of said frame 12 should be made of a high electrical conductivity material (e.g. metal) such that the own structure of element 1 can be used as a conductor so that the use of electric wires and cables are not needed.

The side surfaces of element 1 preferably cooperate with side elements 13 also provided, even partially, with a region of conductive material interconnecting the area contacting with the electric driving system 5 with the end of said side element 13, which comprises any engaging and/or securing means 14 which allow for safe coupling thereof to spans 21 contained in the refrigerator housing support structure 2 of the refrigerator housing for removably holding said element 1. Such spans as well as the engaging and/or securing means of element 1 can be better seen from FIG. 4.

It should be emphasized that the two side elements 13 of said elements 1 will be preferably coupled to corresponding support structures; however, only one of such structures is needed to energize the element 1 such that costs for mounting the equipment are reduced.

With regard to fixed structure 2 of the present invention, same comprises a conductive region 21 cooperative with conductive material 6 of element 1, wherein said conductive regions 21 are connected to positive and negative poles of an electric power source 7, preferably a low voltage source.

Therefore, the device as depicted in the figures comprised means for permitting wireless electric connection between at least one element 1 removably secured to at least a support structure 2 of housing 3 of an equipment.

The electric power source can be a low voltage DC power source or another similar equipment which preferably is hidden inside the apparatus housing or in its outer region (not shown) and connected so as to energize the metal portion of element 1 whenever the refrigerator door opens and whenever said element 1 is duly coupled to the support structure 2 of housing 3.

Hence, when said element 1 is duly coupled to said housing 3 and the refrigerator door opens, the contact between said parts will allow energy to flow to electrically or electronically driven device 5 such that same is actuated—in the case causing the LEDs to turn on. Nevertheless, if the refrigerator door opens but the engaging and/or securing means of the removable element 1 are not coupled to the support element 2 no light will turn on because the electric contact will not close.

Analogously, no electric current will pass between the parts while the equipment door is closed.

In a preferred embodiment, the energizing system of the present invention consists of removable shelves 1 with LEDs disposed on the front regions thereof to provide better illumination conditions inside the refrigerated compartment. Said set of LEDs is electrically connected to the metal portion of the shelf. On the other side, a low voltage DC source 7 is energizing at least one metal fixed structure 2 such that LEDs of the shelf turn on when the doors of equipment 1, in this case a refrigerator, opens and the shelf is positioned in the support structure 2, and LEDs turn off when any of the doors of equipment 1 closes or if the shelf 1 is removed from said structure 2. The contact between said metal structure 2 and the shelf support 1 is what feeds LEDs 5.

Attention should be drawn to the fact that although a preferred embodiment of the invention is described, it is to be construed that the drawings are merely illustrative and not limitative since other aesthetic shapes can be used without departing from the scope of the invention to be protected. Additionally, eventual omissions, substitutions and construction modifications can be carried out by a person skilled in the art without departing from the spirit and scope of the invention to be protected. Further all combinations of elements performing the same function and substantially in the same form in order to achieve the same results are herein contemplated and regarded as being within the scope of the invention. Substitutions of elements of an embodiment described by others are also entirely intended and contemplated herein.

1. Energizing system of removable components for equipments in general, more specifically for household appliances comprising elements (1) removably secured to support structures (2) of housing (3) of the equipment (4) wherein said elements (1) are provided with electric or electronic driving devices (5), said system being CHARACTERIZED in that it comprises:
at least one element (1) comprising at least a surface portion containing conductive material (6) cooperative with at least a fixed structure (2) of the equipment (4);
said surface portion containing conductive material (6) connected to said electric driving device (5);
at least one fixed structure (2) comprising at least a conductive region (21) cooperative with the conductive material (6) of element (1), wherein said conductive region (21) is connected to an electric power source (7);
means for allowing wireless electric connection between at least one element (1) removably secured to at least one support structure (2) of the structure (3) of an equipment, and said structure (3) of said equipment.

2. Energizing system, in accordance with claim 1, CHARACTERIZED in that said element (1) comprises:
a transparent flat plate (11) with perimeter covered with a frame (12) provided with, under one or more of its surfaces, an electric or electronic driving device (5);
wherein side elements (12) having ends (13) provided with engaging and/or securing means (14) for coupling with said conductive regions (21) contained on the support structures (2) of the refrigerator housing (3) are disposed together with the side structures of the frame (12).

3. Energizing system, in accordance with claim 2, CHARACTERIZED in that said frame (12) is constituted by electric conductive material at least in the region interconnecting the electric driven device (5) and the conductive regions (21) contained on the support structures (2).

4. Energizing system, in accordance with claim 1, CHARACTERIZED in that the electric driving systems (5) are light emitting diodes (LEDs).

5. Energizing system, in accordance with claim 1, CHARACTERIZED in that said electric power source (7) is a low voltage power source.

6. Energizing system, in accordance with claim 1, CHARACTERIZED in that at least one electric driving system (5) comprises at least one electronic plate.

7. Method of electrically driving devices disposed at removable components for equipments in general, CHARACTERIZED in that it comprises the step of bringing into contact at least a portion of electric conductive surface (6) of a removable element (1) containing at least an electronic component (5) with at least a portion of electric conductive surface (21) of a fixed structure (2), where said fixed structure (2) is connected to an electric power source (7).
